(19) United States
(12) Patent Application Publication
(10) Pub. No.: US 2025/0239952 A1
(43) Pub. Date: Jul. 24, 2025

(54) INTEGRATED CIRCUIT DEVICE AND MOTOR DRIVER

(71) Applicant: SEIKO EPSON CORPORATION, Tokyo (JP)

(72) Inventors: Katsumi Inoue, Matsumoto-shi (JP); Kazuhiro Maekawa, Chino-shi (JP); Nobuhiro Takahashi, Chino-shi (JP)

(21) Appl. No.: 19/027,912

(22) Filed: Jan. 17, 2025

(30) Foreign Application Priority Data
Jan. 19, 2024 (JP) 2024-006841

(51) Int. Cl. H02P 8/12; H02P 8/34

(52) U.S. Cl. CPC H02P 8/12; H02P 8/34

(57) ABSTRACT

An integrated circuit device includes: a first bridge circuit; a first current detection circuit; a control circuit; a first terminal coupled to one end of a first sense resistor and the first bridge circuit; a second terminal coupled to the one end of the first sense resistor; and a first wiring. The first bridge circuit is provided closer to a first side than the control circuit. The first current detection circuit is provided closer to a second side than the control circuit. The first terminal and the second terminal are provided closer to the first side than the control circuit. The first wiring couples the second terminal to an input node of the first current detection circuit.

The present application is based on, and claims priority from JP Application Serial Number 2024-006841, filed Jan. 19, 2024, the disclosure of which is hereby incorporated by reference herein in its entirety.

### BACKGROUND

### 1. Technical Field

The present disclosure relates to an integrated circuit device, a motor driver, or the like.

### 2. Related Art

JP-A-2015-136277 discloses a circuit device for driving a motor. The circuit device includes a bridge circuit, a first terminal, a second terminal, a third terminal, and a differential amplifier circuit. The third terminal is coupled to a source side of a low-side transistor and one end of a sense resistor provided in the bridge circuit. The first terminal is coupled to the one end of the sense resistor and a first input node of the differential amplifier circuit. The second terminal is coupled to the other end of the sense resistor and a second input node of the differential amplifier circuit.

JP-A-2015-136277 is an example of the related art.

FIG. 6 in JP-A-2015-136277 shows a layout configuration example of the circuit device. A first bridge circuit region, a driver circuit region, an analog circuit region, and a logic circuit region are disposed in this order in a first direction from a second side. The analog circuit region includes a detection circuit including the differential amplifier circuit. In JP-A-2015-136277, since the analog circuit region is closer to the bridge circuit than the logic circuit region, the analog circuit region is easily affected by noise generated by the bridge circuit. JP-A-2015-136277 does not disclose or suggest a layout of a circuit, a terminal, a wiring, or the like when the analog circuit region and the bridge circuit are disposed away from each other.

### SUMMARY

An aspect of the disclosure relates to an integrated circuit device including: a first bridge circuit configured to drive a motor; a first current detection circuit configured to detect a first current flowing through a first sense resistor; a control circuit configured to control the first bridge circuit based on a detection result of the first current detection circuit; a first terminal coupled to one end of the first sense resistor and the first bridge circuit; a second terminal coupled to the one end of the first sense resistor; and a first wiring. The first bridge circuit is provided closer to a first side of the integrated circuit device than the control circuit. The first current detection circuit, when an opposite side of the first side is defined as a second side of the integrated circuit device, is provided closer to the second side than the control circuit. The first terminal and the second terminal are provided closer to the first side than the control circuit. The first wiring couples the second terminal provided closer to the first side than the control circuit to an input node of the first current detection circuit provided closer to the second side than the control circuit.

Another aspect of the disclosure relates to a motor driver including the integrated circuit device and the first sense resistor.

### BRIEF DESCRIPTION OF THE DRAWINGS

FIG. 1 is a first layout configuration example of an integrated circuit device.

FIG. 2 is a second layout configuration example of the integrated circuit device.

FIG. 3 is a third layout configuration example of the integrated circuit device.

FIG. 4 is a circuit configuration example of the integrated circuit device.

FIG. 5 is a detailed circuit configuration example of a first current detection circuit.

FIG. 6 is a detailed circuit configuration example of a control circuit.

FIG. 7 is a diagram showing a drive method when the integrated circuit device drives a stepping motor.

FIG. 8 is a first detailed layout configuration example of the integrated circuit device.

FIG. 9 is a second detailed layout configuration example of the integrated circuit device.

FIG. 10 is a third detailed layout configuration example of the integrated circuit device.

FIG. 11 is a fourth detailed layout configuration example of the integrated circuit device.

### DESCRIPTION OF EMBODIMENTS

A preferred embodiment of the disclosure will be described in detail below. The embodiment described below does not unduly limit the content described in the claims. Not all of configurations described in the embodiment are essential constituent elements.

For example, an example in which an integrated circuit device drives a two-phase stepping motor will be described below, but the integrated circuit device may drive a single-phase motor such as a DC motor. The latter integrated circuit device may include only single-phase circuit and a layout among two-phase circuits and layouts of the integrated circuit device described below.

### 1. First and Second Layout Configuration Examples

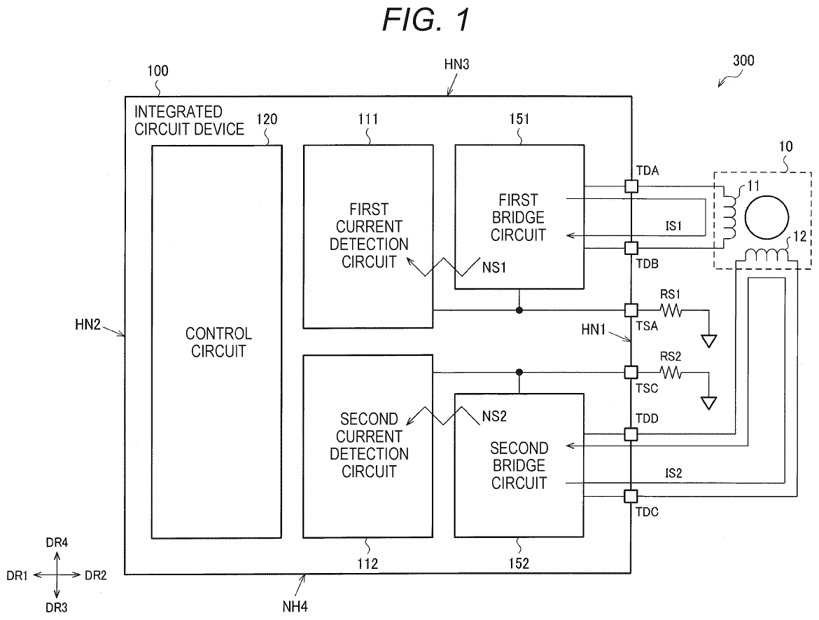

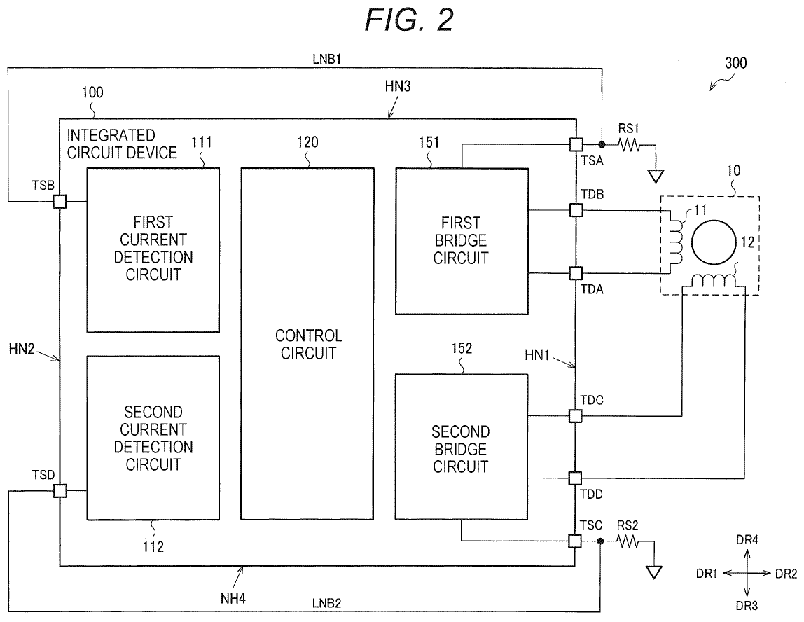

Problems of a motor driver will be described with reference to FIGS. 1 and 2.

FIG. 1 is a first layout configuration example of the integrated circuit device. A motor driver 300 is a driver that drives a motor 10, and includes an integrated circuit device 100, a first sense resistor RS1, and a second sense resistor RS2. The motor 10 is a two-phase stepping motor, and includes a first coil 11 and a second coil 12. The sense resistor is also referred to as a shunt resistor.

The integrated circuit device 100 is a semiconductor chip in which a plurality of circuit elements are integrated on a semiconductor substrate. An opposite side of a first side HN1 of the semiconductor chip is defined as a second side HN2, a side intersecting the first side HN1 and the second side HN2 is defined as a third side HN3, and an opposite side of the third side HN3 is defined as a fourth side HN4. A direction from the first side HN1 toward the second side HN2 is defined as a first direction DR1, a direction opposite to the first direction DR1 is defined as a second direction DR2, a direction from the third side HN3 toward the fourth side HN4 is defined as a third direction DR3, and a direction opposite to the third direction DR3 is defined as a fourth direction DR4.

The integrated circuit device 100 includes a first bridge circuit 151 that drives the first coil 11 of the motor 10, a first current detection circuit 111 that detects a first current flowing through the first sense resistor RS1, and a terminal TSA coupled to one end of the first sense resistor RS1, the first bridge circuit 151, and the first current detection circuit 111. The integrated circuit device 100 includes a terminal TDA coupled to one end of the first coil 11 and the first bridge circuit 151, and a terminal TDB coupled to the other end of the first coil 11 and the first bridge circuit 151. The other end of the first sense resistor RS1 is coupled to a ground node. An absolute value of the first current is the same as an absolute value of a drive current IS1 of the first coil 11. That is, the first current detection circuit 111 substantially detects the drive current IS1 of the first coil 11. The terminals TSA, TDA, and TDB are disposed at the first side HN1 side.

The integrated circuit device 100 also includes a second bridge circuit 152 that drives the second coil 12 of the motor 10, a second current detection circuit 112 that detects a second current flowing through the second sense resistor RS2, and a terminal TSC coupled to one end of the second sense resistor RS2, the second bridge circuit 152, and the second current detection circuit 112. The integrated circuit device 100 also includes a terminal TDC coupled to one end of the second coil 12 and the second bridge circuit 152, and a terminal TDD coupled to the other end of the second coil 12 and the second bridge circuit 152. The other end of the second sense resistor RS2 is coupled to the ground node. An absolute value of the second current is the same as an absolute value of a drive current IS2 of the second coil 12. That is, the second current detection circuit 112 substantially detects the drive current IS2 of the second coil 12. The terminals TSC, TDC, and TDD are disposed at the first side HN1 side.

The terminals TSA, TSC, and TDA to TDD of the integrated circuit device 100 are pads provided at the semiconductor chip. The semiconductor chip of the integrated circuit device 100 is accommodated in a package. The packaged integrated circuit device 100, the first sense resistor RS1, and the second sense resistor RS2 are mounted on a circuit substrate such as a printed substrate. Although the terminals TSA, TSC, and TDA to TDD of the integrated circuit device 100 are shown on the side of the semiconductor chip, these terminals may be disposed in the vicinity of the shown side, and may not necessarily be in contact with the side.

Definitions of the sides and the directions, points related to basic operations and mounting of the circuits, and relationships between the terminals and the sides described above are the same in FIG. 2 and the subsequent drawings.

In the layout configuration example of FIG. 1, a control circuit 120 is disposed at the second side HN2 side. The first current detection circuit 111 and the second current detection circuit 112 are disposed in the second direction DR2 of the control circuit 120. The first bridge circuit 151 is disposed in the second direction DR2 of the first current detection circuit 111, and the second bridge circuit 152 is disposed in the second direction DR2 of the second current detection circuit 112.

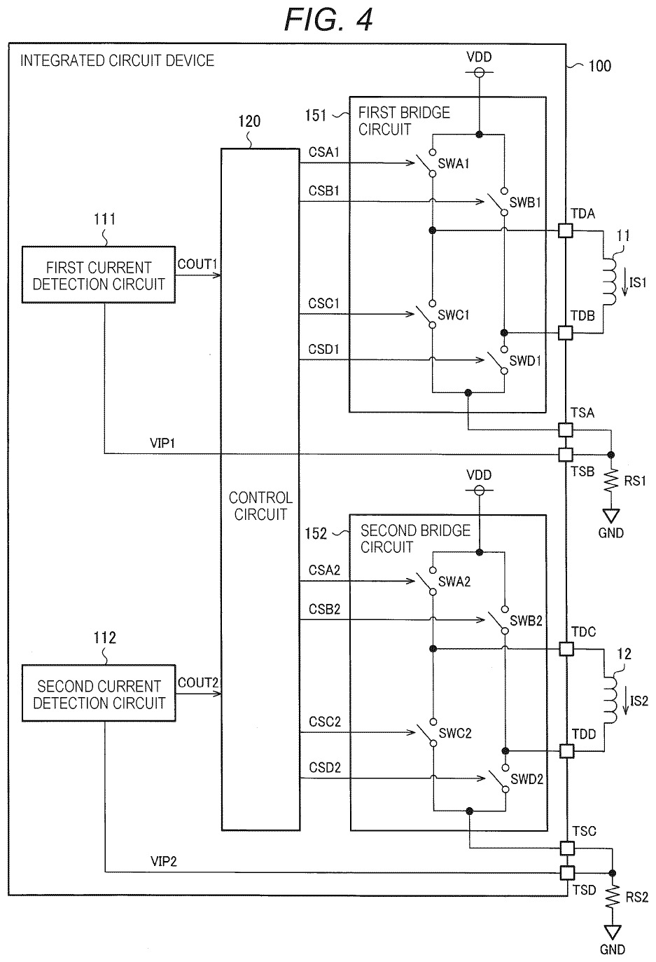

The first bridge circuit 151 and the second bridge circuit 152 generate noise because the motor 10 is driven by switching as described later in FIG. 4. In the layout configuration example of FIG. 1, since the first current detection circuit 111 and the first bridge circuit 151 are disposed adjacent to each other, noise NS1 generated by the first bridge circuit 151 is easily transmitted to the first current detection circuit 111 through the semiconductor substrate or the like. Since the second current detection circuit 112 and the second bridge circuit 152 are disposed adjacent to each other, noise NS2 generated by the second bridge circuit 152 is easily transmitted to the second current detection circuit 112 through the semiconductor substrate or the like. Therefore, the first current detection circuit 111 or the second current detection circuit 112 may malfunction, and the motor 10 may not be appropriately driven. For example, an error is included in a detected current value due to the noises NS1 and NS2, and the drive currents IS1 and IS2 deviate from desired current values, or abnormality detection operates due to the noises NS1 and NS2 and the driving stops.

FIG. 2 is a second layout configuration example of the integrated circuit device. Description of parts similar to those in FIG. 1 is omitted.

In the layout configuration example of FIG. 2, the first current detection circuit 111 and the second current detection circuit 112 are disposed at the second side HN2 side. The control circuit 120 is disposed in the second direction DR2 of the first current detection circuit 111 and the second current detection circuit 112. The first bridge circuit 151 is disposed in the second direction DR2 of the control circuit 120 and the first current detection circuit 111. The second bridge circuit 152 is disposed in the second direction DR2 of the control circuit 120 and the second current detection circuit 112.

The integrated circuit device 100 includes a terminal TSB coupled to the one end of the first sense resistor RS1 and the first current detection circuit 111, and a terminal TSD coupled to the one end of the second sense resistor RS2 and the second current detection circuit 112. The terminal TSB and the terminal TSD are disposed at the second side HN2 side. The terminal TSB and the one end of the first sense resistor RS1 are coupled to each other through a wiring LNB1 of the circuit substrate. That is, the one end of the first sense resistor RS1 is not coupled to the first current detection circuit 111 through the terminal TSA, but is coupled to the first current detection circuit 111 through the wiring LNB1 of the circuit substrate and the terminal TSB. Similarly, the terminal TSD and the one end of the second sense resistor RS2 are coupled to each other through a wiring LNB2 of the circuit substrate.

By disposing the control circuit 120 between the first current detection circuit 111 and the first bridge circuit 151, the first current detection circuit 111 is disposed away from the first bridge circuit 151, and thus the first current detection circuit 111 is less likely to be affected by the noise from the first bridge circuit 151. Further, by disposing the control circuit 120 between the second current detection circuit 112 and the second bridge circuit 152, the second current detection circuit 112 is disposed away from the second bridge circuit 152, and thus the second current detection circuit 112 is less likely to be affected by the noise from the second bridge circuit 152. Accordingly, malfunction of the first current detection circuit 111 and the second current detection circuit 112 is less likely to occur, and the motor 10 is appropriately driven. For example, it is possible to prevent the driving from being stopped due to the operation of the malfunction detection of the first current detection circuit 111 or the second current detection circuit 112.

However, since the wiring LNB1 and the wiring LNB2 are provided on the circuit substrate, a route method of the wirings is determined depending on a design of the circuit substrate, and resistance values of the wiring LNB1 and the wiring LNB2 are indefinite. Accordingly, an error in current detection may be generated, and drive accuracy of the motor 10 may decrease. For example, the drive current IS1 or the drive current IS2 may have an error with respect to a desired current value. Alternatively, from the viewpoint of the two-phase stepping motor, when the resistance values of the wiring LNB1 and the wiring LNB2 are different from each other, an amplitude of the drive current IS1 and an amplitude of the drive current IS2 are different from each other, and the stepping motor may not be appropriately controlled.

More specifically, the wiring LNB1 is coupled to an input node of an amplifier circuit in the first current detection circuit 111 through the terminal TSB, and the wiring LNB2 is coupled to an input node of an amplifier circuit in the second current detection circuit 112 through the terminal TSD. Therefore, resistances of the wiring LNB1 and the wiring LNB2 are added to an input resistance of the amplifier circuit, and an error is generated in a gain of the amplifier circuit. This gain error causes an error in the current detection, which may cause the above-described problem.

### 2. Third Layout Configuration Example

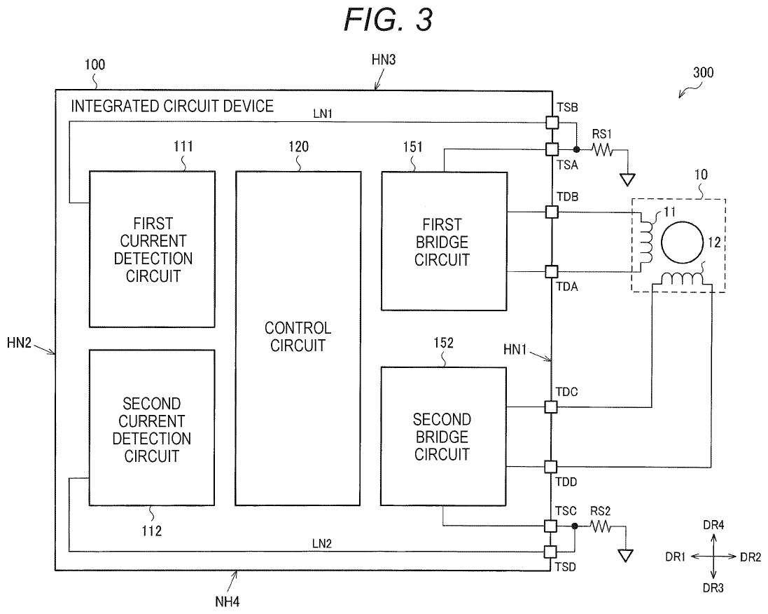

FIG. 3 is a third layout configuration example of the integrated circuit device. In the layout configuration example of FIG. 3, each circuit is disposed in the same manner as in the layout configuration example of FIG. 2. Accordingly, the first current detection circuit 111 is less likely to be affected by the noise from the first bridge circuit 151, and the second current detection circuit 112 is less likely to be affected by the noise from the second bridge circuit 152, and thus malfunction of motor driving is less likely to occur.

Hereinafter, description of parts similar to those in FIG. 1 or FIG. 2 will be omitted. In FIG. 3, the terminals TSA, TSB, TSC, and TSD are referred to as a first terminal, a second terminal, a third terminal, and a fourth terminal, respectively.

In the layout configuration example of FIG. 3, the second terminal TSB and the fourth terminal TSD are disposed at the first side HN1 side of the integrated circuit device 100. The integrated circuit device 100 includes a first wiring LN1 coupling the second terminal TSB and the first current detection circuit 111, and a second wiring LN2 coupling the fourth terminal TSD and the second current detection circuit 112. The first wiring LN1 is provided along an outer periphery of the integrated circuit device 100 at the third side HN3 side. The second wiring LN2 is provided along the outer periphery of the integrated circuit device 100 on the fourth side HN4 side.

More specifically, one end of the first wiring LN1 is coupled to the second terminal TSB, and the other end is coupled to the input node of the amplifier circuit in the first current detection circuit 111. One end of the second wiring LN2 is coupled to the fourth terminal TSD, and the other end is coupled to the input node of the amplifier circuit in the second current detection circuit 112. The first wiring LN1 is provided along the first direction DR1 between the third side HN3 and each of the first current detection circuit 111, the control circuit 120, and the first bridge circuit 151. The first wiring LN1 may further include not only a portion provided along the first direction DR1 but also a portion provided along the third direction DR3. For example, the other end side of the first wiring LN1 may be provided along the third direction DR3 between the first current detection circuit 111 and the second side HN2. The second wiring LN2 is provided along the first direction DR1 between the fourth side HN4 and each of the second current detection circuit 112, the control circuit 120, and the second bridge circuit 152. The second wiring LN2 may further include not only a portion provided along the first direction DR1 but also a portion provided along the fourth direction DR4. For example, the other end side of the second wiring LN2 may be provided along the fourth direction DR4 between the second current detection circuit 112 and the second side HN2. For example, the first wiring LN1 and the second wiring LN2 are disposed line-symmetrically with respect to a center line between the third side HN3 and the fourth side HN4. The center line is a virtual straight line coupling a midpoint of the first side HN1 and a midpoint of the second side HN2.

According to the layout configuration example, since the first wiring LN1 and the second wiring LN2 are provided in the integrated circuit device 100, resistance values of the first wiring LN1 and the second wiring LN2 can be estimated when the integrated circuit device 100 is designed, without being affected by the circuit substrate. Accordingly, the gain errors of the amplifier circuits in the first current detection circuit 111 and the second current detection circuit 112 are not affected by the circuit substrate, and the appropriate drive current IS1 and drive current IS2 are implemented. From the viewpoint of the two-phase stepping motor, the resistance values of the first wiring LN1 and the second wiring LN2 can be aligned, and the amplitude of the drive current IS1 and the amplitude of the drive current IS2 can be made equal to each other, so that the stepping motor is appropriately controlled.

FIG. 4 is a circuit configuration example of the integrated circuit device. The integrated circuit device 100 includes the first current detection circuit 111, the second current detection circuit 112, the control circuit 120, the first bridge circuit 151, the second bridge circuit 152, the first terminal TSA, the second terminal TSB, the third terminal TSC, the fourth terminal TSD, and the terminals TDA to TDD.

The first current detection circuit 111 detects whether an input voltage VIP1 from the second terminal TSB exceeds a voltage corresponding to a first target current value, and outputs an output signal COUT1 which is a detection result thereof. The input voltage VIP1 is a voltage corresponding to a current flowing through the first sense resistor RS1, and VIP1=RS1×IS1 in a charge period.

The second current detection circuit 112 detects whether an input voltage VIP2 from the fourth terminal TSD exceeds a voltage corresponding to a second target current value, and outputs an output signal COUT2 which is a detection result thereof. The input voltage VIP2 is a voltage corresponding to a current flowing through the second sense resistor RS2, and VIP2=RS2×IS2 in the charge period.

The control circuit 120 outputs pre-drive signals CSA1 to CSD1 for causing switch elements of the first bridge circuit 151 to switch based on the output signal COUT1 of the first current detection circuit 111. The control circuit 120 outputs pre-drive signals CSA2 to CSD2 for causing switch elements of the second bridge circuit 152 to switch based on the output signal COUT2 of the second current detection circuit 112.

The first bridge circuit 151 includes switch elements SWA1 to SWD1. One end of the switch element SWA1 is coupled to a power supply node to which a power supply voltage VDD is supplied, and the other end is coupled to the terminal TDA. One end of the switch element SWB1 is coupled to the power supply node, and the other end is coupled to the terminal TDB. One end of the switch element SWC1 is coupled to the terminal TDA, and the other end is coupled to the first terminal TSA. One end of the switch element SWD1 is coupled to the terminal TDB, and the other end is coupled to the first terminal TSA. The switch element SWA1 is controlled to be turned on or off by the pre-drive signal CSA1. Similarly, the switch elements SWB1 to SWD1 are controlled to be turned on or off by the pre-drive signals CSB1 to CSD1. The switch elements SWA1 and SWB1 are so-called high-side transistors, and are P-type MOS transistors or N-type MOS transistors. The switch elements SWC1 and SWD1 are so-called low-side transistors, and are N-type MOS transistors.

The second bridge circuit 152 includes switch elements SWA2 to SWD2. One end of the switch element SWA2 is coupled to a power supply node to which the power supply voltage VDD is supplied, and the other end is coupled to the terminal TDC. One end of the switch element SWB2 is coupled to the power supply node, and the other end is coupled to the terminal TDD. One end of the switch element SWC2 is coupled to the terminal TDC, and the other end is coupled to the third terminal TSC. One end of the switch element SWD2 is coupled to the terminal TDD, and the other end is coupled to the third terminal TSC. The switch element SWA2 is controlled to be turned on or off by the pre-drive signal CSA2. Similarly, the switch elements SWB2 to SWD2 are controlled to be turned on or off by the pre-drive signals CSB2 to CSD2. The switch elements SWA2 and SWB2 are so-called high-side transistors, and are P-type MOS transistors or N-type MOS transistors. The switch elements SWC2 and SWD2 are so-called low-side transistors, and are N-type MOS transistors.

A case where the first bridge circuit 151 outputs the positive drive current IS1 will be described. The control circuit 120 turns on the switch elements SWA1 and SWD1 and turns off the switch elements SWB1 and SWC1 in the charge period. The control circuit 120 turns off the switch elements SWA1 and SWD1 and turns on the switch elements SWB1 and SWC1 in a decay period. When the charge period and the decay period are combined into a drive cycle, the drive current IS1 is controlled according to a duty ratio of the charge period with respect to the cycle. The control circuit 120 controls the first bridge circuit 151 based on the output signal COUT1 of the first current detection circuit 111 to control the duty ratio of the charge period such that the drive current IS1 corresponds to the target current value.

When the first bridge circuit 151 outputs the negative drive current IS1, the on-off states of the switch elements SWA1 to SWD1 are opposite to those when the first bridge circuit 151 outputs the positive drive current IS1. The control of the second bridge circuit 152 is similar to the control of the first bridge circuit 151. That is, the control circuit 120 controls the second bridge circuit 152 based on the output signal COUT2 of the second current detection circuit 112 to control the duty ratio of the charge period such that the drive current IS2 corresponds to the target current value.

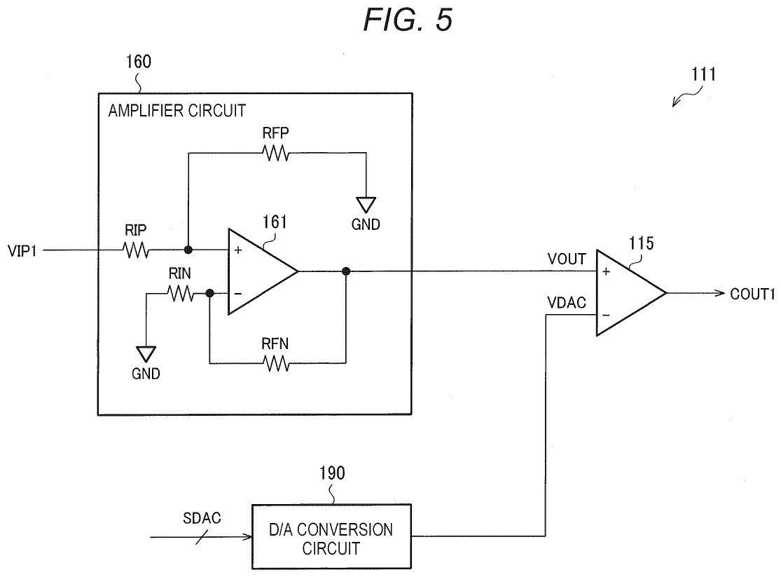

FIG. 5 is a detailed circuit configuration example of the first current detection circuit. Hereinafter, the first current detection circuit 111 will be described as an example, and the second current detection circuit 112 has the same configuration. The first current detection circuit 111 includes an amplifier circuit 160, a D/A conversion circuit 190, and a comparison circuit 115.

The amplifier circuit 160 amplifies the input voltage VIP1 and outputs the amplified voltage as an output voltage VOUT. The amplifier circuit 160 includes an operational amplifier 161, a first resistor RIP, a second resistor RFP, a third resistor RIN, and a fourth resistor RFN.

One end of the first resistor RIP is coupled to a first input terminal of the operational amplifier 161, and the other end is coupled to the terminal TSB. The input voltage VIP1 is input from the second terminal TSB to the other end of the first resistor RIP. One end of the second resistor RFP is coupled to the first input terminal of the operational amplifier 161, and the other end is coupled to the ground node. A reference voltage may be input to the other end of the second resistor RFP. Here, an example in which the reference voltage is a ground voltage is shown. One end of the third resistor RIN is coupled to a second input terminal of the operational amplifier 161, and the other end is coupled to the ground node. One end of the fourth resistor RFN is coupled to the second input terminal of the operational amplifier 161, and the other end is coupled to an output terminal of the operational amplifier 161. An output voltage VOUT is output from the output terminal of the operational amplifier 161. In the example of FIG. 5, the first input terminal of the operational amplifier 161 is a positive input terminal, and the second input terminal is a negative input terminal.

When RIP=RIN, RFP=RFN, and a gain of the amplifier circuit 160 is K, K=RFP/RIP and VOUT=K×VIP1. When a voltage of the ground node is 0 V, a voltage difference between both ends of the first sense resistor RS1 is VIP1−0 V, and the amplifier circuit 160 amplifies the voltage difference between both ends of the first sense resistor RS1.

The D/A conversion circuit 190 performs D/A conversion on a target current value SDAC and outputs the result as an output voltage VDAC. The D/A conversion circuit 190 includes, for example, a ladder resistor circuit and a selection circuit. The ladder resistor circuit divides the power supply voltage VDD into a plurality of voltages. The selection circuit selects a voltage corresponding to the target current value SDAC from the plurality of voltages, and outputs the selected voltage as the output voltage VDAC. The target current value SDAC is written, for example, from a processing device outside the integrated circuit device 100 to a register (not shown) or the like in the integrated circuit device 100. Alternatively, the integrated circuit device 100 may include a target value correction circuit, and the target value correction circuit may correct a target setting value written in a register or the like from an external processing device, and output a correction value obtained therefrom as the target current value SDAC.

The output voltage VOUT of the amplifier circuit 160 is input to a first input terminal of the comparison circuit 115. The output voltage VDAC of the D/A conversion circuit 190 is input to a second input terminal thereof. The comparison circuit 115 compares the output voltage VOUT of the amplifier circuit 160 with the output voltage VDAC of the D/A conversion circuit 190, and outputs the comparison result as an output signal COUT1. The comparison circuit 115 is also referred to as a comparator. In the example of FIG. 5, the first input terminal is a positive input terminal, and the second input terminal is a negative input terminal.

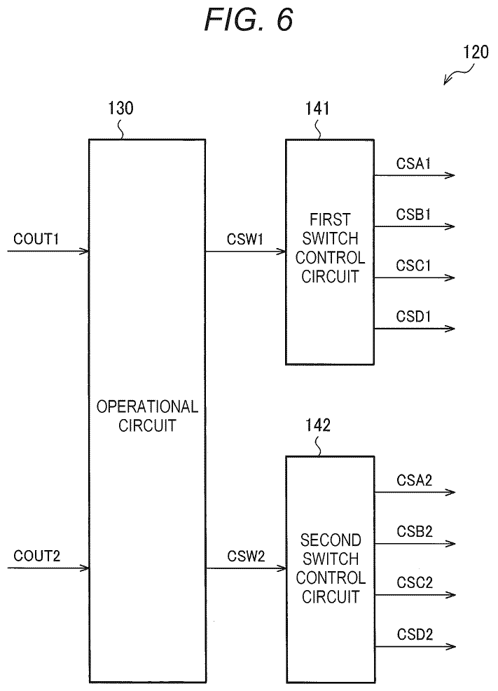

FIG. 6 is a detailed circuit configuration example of the control circuit. The control circuit 120 includes an operational circuit 130, a first switch control circuit 141, and a second switch control circuit 142.

The operational circuit 130 generates a switching control signal CSW1 from the output signal COUT1 of the first current detection circuit 111, and generates a switching control signal CSW2 from the output signal COUT2 of the second current detection circuit 112. Hereinafter, generation processing of the switching control signal CSW1 will be described as an example, and generation processing of the switching control signal CSW2 is also the same. The operational circuit 130 includes a timer as an example. Here, the comparison circuit 115 outputs a high-level output signal COUT1 when VOUT>VDAC. A charge period is set when the switching control signal CSW1 is at a high level, and a decay period is set when the switching control signal CSW1 is at a low level. The operational circuit 130 sets the switching control signal CSW1 from the low level to the high level at a rising edge of the output signal COUT1, and activates the timer. When a measurement time of the timer reaches a predetermined time, the operational circuit 130 changes the switching control signal CSW1 from the high level to the low level and stops the timer. Thereafter, the charge period and the decay period are repeated by repeating the same operation.

The first switch control circuit 141 generates the pre-drive signals CSA1 to CSD1 from the switching control signal CSW1. Specifically, the first switch control circuit 141 includes a logic circuit that generates on-off control signals of the switch elements SWA1 to SWD1 from the switching control signal CSW1, and a buffer circuit that buffers the on-off control signals of the switch elements SWA1 to SWD1 and outputs the pre-drive signals CSA1 to CSD1.

The second switch control circuit 142 generates the pre-drive signals CSA2 to CSD2 from the switching control signal CSW2. Specifically, the second switch control circuit 142 includes a logic circuit that generates on-off control signals of the switch elements SWA2 to SWD2 from the switching control signal CSW2, and a buffer circuit that buffers the on-off control signals of the switch elements SWA2 to SWD2 and outputs the pre-drive signals CSA2 to CSD2.

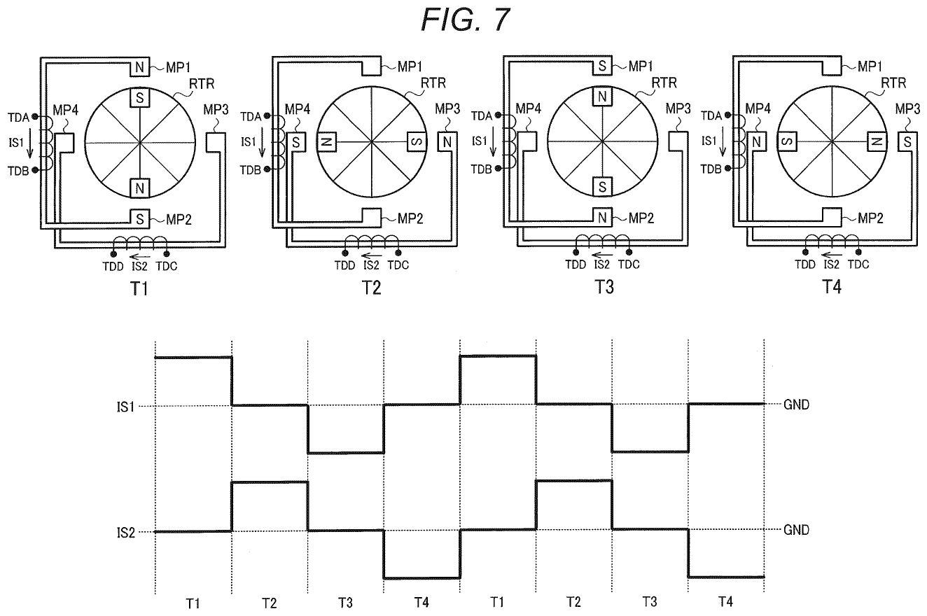

FIG. 7 is a diagram showing a drive method when the integrated circuit device drives the stepping motor. Hereinafter, driving of a quadrupole bipolar motor will be described as an example, but the disclosure is not limited thereto.

As shown in FIG. 7, the stepping motor makes one rotation in first to fourth steps T1 to T4. In the first step T1, the drive current IS1 of the first bridge circuit 151 is positive, and the drive current IS2 of the second bridge circuit 152 is zero. A first pole MP1 becomes an N-pole and attracts an S-pole of a stator RTR, and a second pole MP2 becomes an S-pole and attracts an N-pole of the stator RTR. A rotation angle of the stepping motor is 0 degrees. In the second step T2, the drive current IS1 of the first bridge circuit 151 is zero, and the drive current IS2 of the second bridge circuit 152 is positive. A third pole MP3 becomes an N-pole and attracts the S-pole of the stator RTR, and a fourth pole MP4 becomes an S-pole and attracts the N-pole of the stator RTR. The rotation angle of the stepping motor is 90 degrees. In the third step T3, the drive current IS1 of the first bridge circuit 151 is negative, and the drive current IS2 of the second bridge circuit 152 is zero. The first pole MP1 becomes an S-pole and attracts the N-pole of the stator RTR, and the second pole MP2 becomes an N-pole and attracts the S-pole of the stator RTR. The rotation angle of the stepping motor is 180 degrees. In the fourth step T4, the drive current IS1 of the first bridge circuit 151 is zero, and the drive current IS2 of the second bridge circuit 152 is negative. The third pole MP3 becomes an S-pole and attracts the N-pole of the stator RTR, and the fourth pole MP4 becomes an N-pole and attracts the S-pole of the stator RTR. The rotation angle of the stepping motor is 270 degrees.

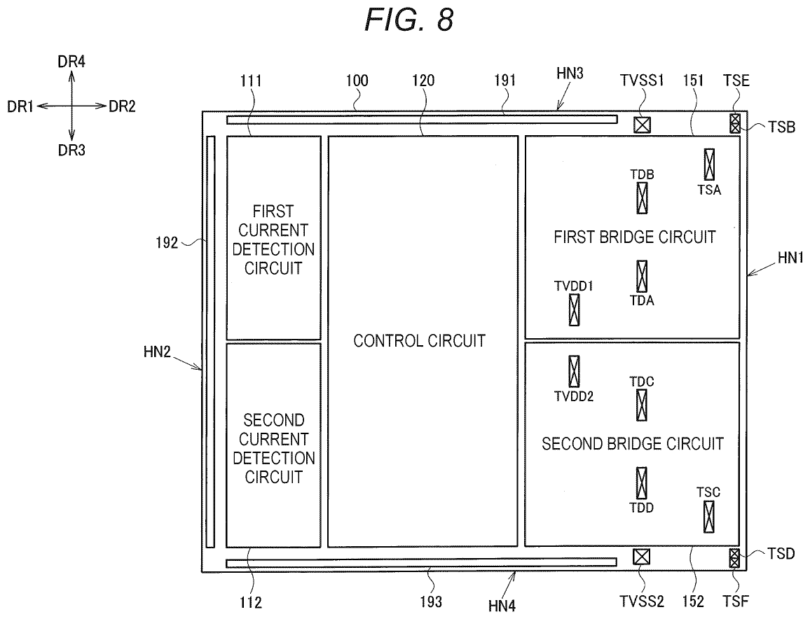

FIG. 8 is a first detailed layout configuration example of the integrated circuit device. Description of parts similar to those in FIG. 3 is omitted.

The integrated circuit device 100 includes a fifth terminal TSE and a sixth terminal TSF, which are coupled to the ground node, at the circuit substrate on which the integrated circuit device 100 is mounted. The fifth terminal TSE is coupled to the ground node of the amplifier circuit provided in the first current detection circuit 111 by the wiring in the integrated circuit device 100. Specifically, the fifth terminal TSE is coupled to the other end of the third resistor RIN in the operational circuit 130 of FIG. 5 by the wiring in the integrated circuit device 100. Similarly, the sixth terminal TSF is coupled to the ground node of the amplifier circuit provided in the second current detection circuit 112 by the wiring in the integrated circuit device 100.

The second terminal TSB and the fifth terminal TSE are disposed at a corner portion where the first side HN1 and the third side HN3 intersect. The fourth terminal TSD and the sixth terminal TSF are disposed at a corner portion where the first side HN1 and the fourth side HN4 intersect.

The integrated circuit device 100 includes terminals TVDD1 and TVDD2. The terminal TVDD1 is a terminal coupled to the power supply node at the circuit substrate, and supplies the power supply voltage VDD to the first bridge circuit 151. The terminal TVDD2 is a terminal coupled to the power supply node at the circuit substrate, and supplies the power supply voltage VDD to the second bridge circuit 152.

The terminals TVDD1, TDA, and TDB and the first terminal TSA are disposed in an arrangement region of the first bridge circuit 151. The terminals TDA and TDB are disposed along the fourth direction DR4 in the vicinity of a center of the arrangement region of the first bridge circuit 151. The first terminal TSA is disposed at a corner portion close to the second terminal TSB in the arrangement region of the first bridge circuit 151. The terminal TVDD1 is disposed at a diagonal corner portion of the corner portion where the first terminal TSA is disposed in the arrangement region of the first bridge circuit 151.

The terminals TVDD2, TDC, and TDD and the third terminal TSC are disposed in an arrangement region of the second bridge circuit 152. The terminals TDC and TDD are disposed along the third direction DR3 in the vicinity of a center of the arrangement region of the second bridge circuit 152. The third terminal TSC is disposed at a corner portion close to the fourth terminal TSD in the arrangement region of the second bridge circuit 152. The terminal TVDD2 is disposed at a diagonal corner portion of the corner portion where the third terminal TSC is disposed in the arrangement region of the second bridge circuit 152.

The integrated circuit device 100 includes terminals TVSS1 and TVSS2. The terminal TVSS1 and the terminal TVSS2 are terminals that are coupled to the ground node at the circuit substrate and supply a ground potential to the entire integrated circuit device 100. The integrated circuit device 100 includes I/O regions 191 to 193. A plurality of pads for inputting and outputting signals from and to the outside of the integrated circuit device 100 are disposed in each I/O region.

The I/O region 191 is disposed along the third side HN3 between the third side HN3 and each of the first current detection circuit 111, the control circuit 120, and the first bridge circuit 151. The I/O region 192 is disposed along the second side HN2 between the second side HN2 and each of the first current detection circuit 111 and the second current detection circuit 112. The I/O region 193 is disposed along the fourth side HN4 between the fourth side HN4 and each of the second current detection circuit 112, the control circuit 120, and the second bridge circuit 152. The terminal TVSS1 is disposed at the third side HN3. Specifically, the terminal TVSS1 is disposed between the first bridge circuit 151 and the third side HN3, and is disposed in the second direction DR2 of the I/O region 191. The terminal TVSS2 is disposed at the fourth side HN4. Specifically, the terminal TVSS2 is disposed between the second bridge circuit 152 and the fourth side HN4, and is disposed in the second direction DR2 of the I/O region 193.

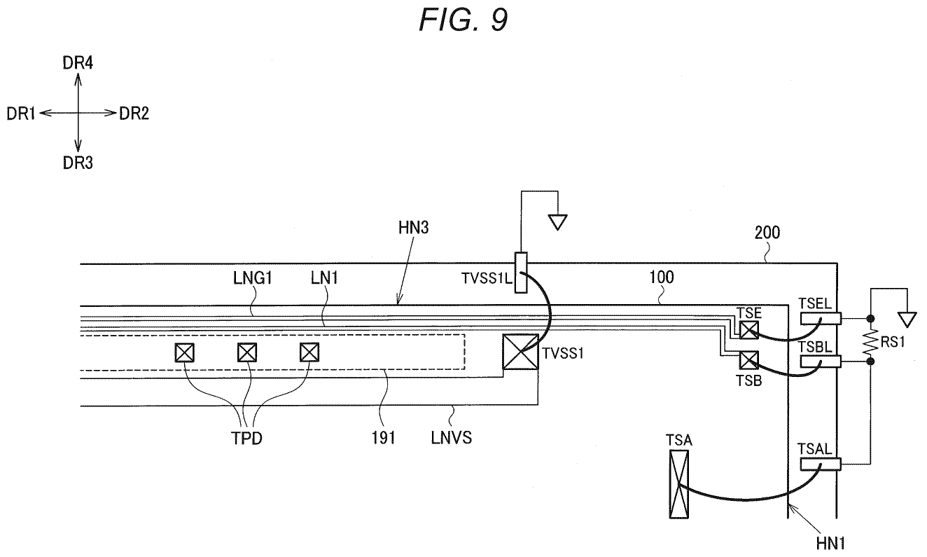

FIG. 9 is a second detailed layout configuration example of the integrated circuit device. Here, a layout example in a periphery between the first bridge circuit 151 and each of the first side HN1 and the third side HN3 is shown. A layout in a periphery between the second bridge circuit 152 and each of the first side HN1 and the fourth side HN4 is line-symmetric to FIG. 9 with respect to the center line between the third side HN3 and the fourth side HN4.

The integrated circuit device 100 is accommodated in a package 200. The integrated circuit device 100 includes lead terminals bonded to pads of the integrated circuit device 100. The pad of the integrated circuit device 100 is coupled to the wiring of the circuit substrate through the lead terminal of the package. FIG. 9 shows a lead terminal TVSS1L bonded to the terminal TVSS1, a lead terminal TSAL bonded to the first terminal TSA, a lead terminal TSBL bonded to the second terminal TSB, and a lead terminal TSEL bonded to the fifth terminal TSE. In the circuit substrate, the lead terminals TSAL and TSBL are coupled to the one end of the first sense resistor RS1, and the lead terminal TSEL is coupled to the other end of the first sense resistor RS1, that is, the ground node. In the circuit substrate, the lead terminal TVSS1L is coupled to the ground node.

The first wiring LN1 coupling the second terminal TSB and the first current detection circuit 111 is provided along the first direction DR1 between the third side HN3 and the I/O region 191 where a plurality of pads TPD are disposed. Similarly, a wiring LNG1 coupling the fifth terminal TSE and the first current detection circuit 111 is provided along the first direction DR1 between the I/O region 191 and the third side HN3. A ground wiring LNVS is coupled to the terminal TVSS1, and is provided along the first direction DR1 in the third direction DR3 of the I/O region 191. Although only a part of the ground wiring LNVS is shown in FIG. 9, the ground wiring LNVS is wired to the terminal TVSS2 along the inside of the I/O regions 191 to 193. Each of the first wiring LN1, the wiring LNB1, and the ground wiring LNVS includes an uppermost metal layer of the integrated circuit device 100. The uppermost metal layer is, for example, a metal layer used for a pad.

As described above, by disposing the first wiring LN1 and the wiring LNB1 along the outer periphery of the integrated circuit device 100, the terminals TSB and TSE can be coupled to the first current detection circuit 111 in a shortest distance without being affected by the wirings in the circuit.

In addition to the pads, an electrostatic protection circuit is provided in the I/O regions 191 to 193, and the ground wiring LNVS for coupling to the electrostatic protection circuit is provided along the I/O regions 191 to 193. By providing the first wiring LN1 and the wiring LNB1 between the I/O region 191 and the third side HN3, the first wiring LN1 and the wiring LNB1 can be disposed using the uppermost metal layer having a small resistance value while avoiding the ground wiring LNVS provided inside the I/O region 191. By using the uppermost metal layer, a parasitic resistance value of the first wiring LN1 and the wiring LNB1 can be reduced, and a gain error of the amplifier circuit due to the parasitic resistance can be reduced.

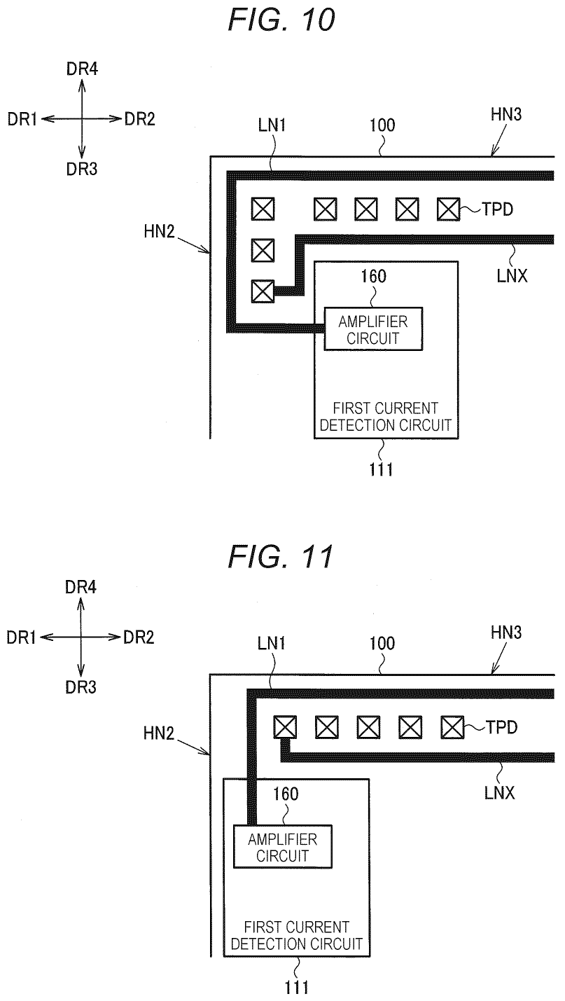

FIG. 10 is a third detailed layout configuration example of the integrated circuit device. Here, a layout example in a periphery between the first current detection circuit 111 and each of the second side HN2 and the third side HN3 is shown. A layout in a periphery between the second current detection circuit 112 and each of the second side HN2 and the fourth side HN4 is line-symmetric to FIG. 10 with respect to the center line between the third side HN3 and the fourth side HN4.

In FIG. 10, at a corner portion where the second side HN2 and the third side HN3 intersect, the plurality of pads TPD in the I/O region are disposed at both the second side HN2 and the third side HN3. A wiring LNX extends along the first direction DR1 inside the plurality of pads TPD provided along the third side HN3. Furthermore, the wiring LNX extends along the third direction DR3 inside the plurality of pads TPD provided along the second side HN2, and one end of the wiring LNX is coupled to the pad TPD. In the example of FIG. 10, the one end of the wiring LNX is coupled to the pad TPD on the most third direction DR3 side among the three pads TPD provided along the second side HN2. The wiring LNX includes the uppermost metal layer.

The first wiring LN1 extends along the first direction DR1 between the pads TPD and the third side HN3, and extends along the third direction DR3 between the pads TPD and the second side HN2. Then, the first wiring LN1 extends in the second direction DR2 through the third direction DR3 side of the pad TPD to which the one end of the wiring LNX is coupled, and is coupled to the amplifier circuit 160 of the first current detection circuit 111.

FIG. 11 is a fourth detailed layout configuration example of the integrated circuit device. Here, a layout example in the periphery between the first current detection circuit 111 and each of the second side HN2 and the third side HN3 is shown. A layout in the periphery between the second current detection circuit 112 and each of the second side HN2 and the fourth side HN4 is line-symmetric to FIG. 11 with respect to the center line between the third side HN3 and the fourth side HN4.

In FIG. 11, at the corner portion where the second side HN2 and the third side HN3 intersect, the plurality of pads TPD in the I/O region are disposed at the third side HN3, and the pads TPD are not disposed at the second side HN2. The wiring LNX extends along the first direction DR1 inside the plurality of pads TPD provided along the third side HN3, and the one end of the wiring LNX is coupled to the pad TPD. In the example of FIG. 11, the one end of the wiring LNX is coupled to the pad TPD on the most first direction DR1 side among the five pads TPD provided along the third side HN3. The wiring LNX includes the uppermost metal layer.

The first wiring LN1 extends along the first direction DR1 between the pads TPD and the third side HN3. Then, the first wiring LN1 extends in the third direction DR3 through the first direction DR1 side of the pad TPD to which the one end of the wiring LNX is coupled, and is coupled to the amplifier circuit 160 of the first current detection circuit 111.

In the embodiment, the integrated circuit device 100 includes the first bridge circuit 151 that drives the motor 10 and the first current detection circuit 111 that detects the first current flowing through the first sense resistor RS1. The integrated circuit device 100 also includes the control circuit 120 that controls the first bridge circuit 151 based on the detection result of the first current detection circuit 111. The integrated circuit device 100 also includes the first terminal TSA coupled to the one end of the first sense resistor RS1 and the first bridge circuit 151, the second terminal TSB coupled to the one end of the first sense resistor RS1, and the first wiring LN1. The opposite side of the first side HN1 of the integrated circuit device 100 is defined as the second side HN2. The first bridge circuit 151 is provided closer to the first side HN1 than the control circuit 120. The first current detection circuit 111 is provided closer to the second side HN2 than the control circuit 120. The first terminal TSA and the second terminal TSB are provided closer to the first side HN1 than the control circuit 120. The first wiring LN1 couples the second terminal TSB provided closer to the first side HN1 than the control circuit 120 to an input node of the first current detection circuit 111 provided closer to the second side HN2 than the control circuit 120.

As described in FIG. 2, when the one end of the first sense resistor RS1 and the input node of the first current detection circuit 111 are coupled to each other by the wiring at the circuit substrate on which the integrated circuit device 100 is mounted, the parasitic resistance value of the wiring varies depending on the design of the circuit substrate, which leads to a detection error of the first current detection circuit 111. According to the embodiment, the one end of the first sense resistor RS1 and the input node of the first current detection circuit 111 are coupled to the first wiring LN1 in the integrated circuit device 100. A parasitic resistance value of the first wiring LN1 can be estimated when designing the integrated circuit device 100, without being affected by the circuit substrate on which the integrated circuit device 100 is mounted, and the detection error of the first current detection circuit 111 is reduced. Accordingly, it is possible to reduce an error between the target current value and the drive current IS1 for driving the motor 10.

FIG. 3 shows an example in which the first terminal TSA and the second terminal TSB are provided on the first side HN1. FIG. 8 shows an example in which the first terminal TSA and the second terminal TSB are disposed in the vicinity of the corner portion where the first side HN1 and the third side HN3 intersect. However, the first terminal TSA and the second terminal TSB may be provided closer to the first side HN1 than the control circuit 120. For example, the first terminal TSA and the second terminal TSB may be provided between the first bridge circuit 151 and the first side HN1, between the first bridge circuit 151 and the third side HN3, or within the arrangement region of the first bridge circuit 151.

In the embodiment, the direction from the first side HN1 toward the second side HN2 may be defined as the first direction DR1. The first wiring LN1 is wired along the first direction DR1.

By wiring the first wiring LN1 along the first direction DR1, the second terminal TSB provided closer to the first side HN1 than the control circuit 120 and the input node of the first current detection circuit 111 provided closer to the second side HN2 than the control circuit 120 can be coupled to each other linearly, that is, in a short distance as much as possible. By shortening the first wiring LN1, the parasitic resistance value can be reduced, and the detection error of the first current detection circuit 111 can be reduced.

In the embodiment, the side intersecting the first side HN1 and the second side HN2 may be defined as the third side HN3 of the integrated circuit device 100. The first wiring LN1 may be wired along the first direction DR1 between the third side HN3 and each of the first bridge circuit 151, the control circuit 120, and the first current detection circuit 111.

According to the embodiment, the first wiring LN1 can be wired along the outer periphery of the integrated circuit device 100. Accordingly, the first wiring LN1 can be made linear, that is, as short as possible, without being affected by the wirings in the circuit of the integrated circuit device 100. The first wiring LN1 can be formed using a metal layer having a resistance value as low as possible, without being affected by the wirings in the circuit of the integrated circuit device 100. Thus, the parasitic resistance value of the first wiring LN1 can be reduced.

In the embodiment, the integrated circuit device 100 includes the plurality of pads provided along the third side HN3. The first wiring LN1 may be wired between the plurality of pads and the third side HN3. In the embodiment, the first wiring LN1 may be wired along the first direction DR1 between the plurality of pads and the third side HN3.

A region between the pad and the side is usually a region where a circuit is not disposed. According to the embodiment, since the first wiring LN1 is wired between the plurality of pads and the third side HN3, the first wiring LN1 can be wired as short as possible.

In the embodiment, the first wiring LN1 may be a wiring formed of the uppermost metal layer of the integrated circuit device 100. In the embodiment, the ground wiring LNVS formed of the uppermost metal layer may be wired along the first direction DR1 inside the plurality of pads. The first wiring LN1 formed of the uppermost metal layer may be wired along the first direction DR1 between the plurality of pads and the third side HN3.

According to the embodiment, the first wiring LN1 is wired between the plurality of pads and the third side HN3. Accordingly, the first wiring LN1 formed of the uppermost metal layer can be wired while avoiding the ground wiring LNVS formed of the uppermost metal layer wired inside the plurality of pads. Since the uppermost metal layer has a resistance value lower than the other metal layers, the parasitic resistance value of the first wiring LN1 can be reduced.

In the embodiment, the first terminal TSA and the second terminal TSB may be disposed at the corner portion where the third side HN3 and the first side HN1 of the integrated circuit device 100 intersect.

Since the drive current IS1 flows between the first bridge circuit 151 and the first sense resistor RS1, the first terminal TSA on the current path is preferably disposed near the first bridge circuit 151. According to the embodiment, the first bridge circuit 151 is disposed closer to the first side HN1 than the control circuit 120, and the first terminal TSA and the second terminal TSB are disposed at the corner portion where the third side HN3 and the first side HN1 intersect. Accordingly, the first terminal TSA is disposed near the first bridge circuit 151. Although the first terminal TSA and the second terminal TSB are coupled to the one end of the first sense resistor RS1 at the circuit substrate, the wiring between the one end of the first sense resistor RS1 and the second terminal TSB at the circuit substrate is shortened by disposing the first terminal TSA and the second terminal TSB at the same corner portion. Accordingly, an influence of a wiring resistance of the circuit substrate on a parasitic resistance value between the one end of the first sense resistor RS1 and the input node of the first current detection circuit 111 can be reduced.

In the embodiment, the first current detection circuit 111 may include the amplifier circuit 160 that amplifies the input voltage VIP1 corresponding to the first current.

According to the embodiment, the input node of the first current detection circuit 111 is an input node of the amplifier circuit 160. The parasitic resistance value of the first wiring LN1 is added to an input resistance value of the amplifier circuit 160, which causes a gain error. Since a variation in the parasitic resistance value of the first wiring LN1 is small or the parasitic resistance value is reduced as described above, the gain error of the amplifier circuit 160 can be reduced and the detection error of the first current detection circuit 111 can be reduced.

In the embodiment, the amplifier circuit 160 may include the operational amplifier 161, the first resistor RIP, the second resistor RFP, the third resistor RIN, and the fourth resistor RFN. The one end of the first resistor RIP may be coupled to the first input terminal of the operational amplifier 161, and the input voltage VIP1 may be input to the other end. The one end of the second resistor RFP may be coupled to the first input terminal of the operational amplifier 161. The one end of the third resistor RIN may be coupled to the second input terminal of the operational amplifier 161, and the other end may be coupled to the ground node. The one end of the fourth resistor RFN may be coupled to the second input terminal of the operational amplifier 161, and the other end may be coupled to the output terminal of the operational amplifier 161.

In the embodiment, the other end of the first resistor RIP to which the input voltage VIP1 is input corresponds to the input node of the first current detection circuit 111. That is, the first wiring LN1 is a wiring coupling the second terminal TSB and the other end of the first resistor RIP.

In the embodiment, the first current detection circuit 111 may include the D/A conversion circuit 190 that performs the D/A conversion on the target current value SDAC of the first current, and the comparison circuit 115 that compares the output voltage VOUT of the amplifier circuit 160 with the output voltage VDAC of the D/A conversion circuit. The control circuit 120 may control the first bridge circuit 151 based on the output signal COUT1 of the comparison circuit 115.

According to the embodiment, the first bridge circuit 151 is controlled such that the first current flowing through the first sense resistor RS1, that is, the drive current IS1 for the first bridge circuit 151 to drive the motor 10 is a current value indicated by the target current value SDAC.

In the embodiment, the integrated circuit device 100 may include the second bridge circuit 152 that drives the motor 10 and the second current detection circuit 112 that detects the second current flowing through the second sense resistor RS2. The integrated circuit device 100 may include the third terminal TSC coupled to the one end of the second sense resistor RS2 and the second bridge circuit 152, the fourth terminal TSD coupled to the one end of the second sense resistor RS2, and the second wiring LN2. The control circuit 120 may control the second bridge circuit 152 based on a detection result of the second current detection circuit 112. The second bridge circuit 152 may be provided closer to the first side HN1 than the control circuit 120. The second current detection circuit 112 may be provided closer to the second side HN2 than the control circuit 120. The third terminal TSC and the fourth terminal TSD may be provided closer to the first side HN1 than the control circuit 120. The second wiring LN2 may couple the fourth terminal TSD provided closer to the first side HN1 than the control circuit 120 to an input node of the second current detection circuit 112 provided closer to the second side HN2 than the control circuit 120.

According to the embodiment, the one end of the second sense resistor RS2 and the input node of the second current detection circuit 112 are coupled to each other by the second wiring LN2 in the integrated circuit device 100. A parasitic resistance value of the second wiring LN2 can be estimated when designing the integrated circuit device 100, without being affected by the circuit substrate on which the integrated circuit device 100 is mounted, and a detection error of the second current detection circuit 112 is reduced. Accordingly, it is possible to reduce an error between the target current value and the drive current IS2 for driving the motor 10. From the viewpoint of the two-phase stepping motor, the resistance values of the first wiring LN1 and the second wiring LN2 can be aligned, and the amplitude of the drive current IS1 and the amplitude of the drive current IS2 can be made equal to each other, so that the stepping motor is appropriately controlled.

In the embodiment, when the opposite side of the third side HN3 is defined as the fourth side HN4 of the integrated circuit device 100, the first wiring LN1 may be wired along the first direction DR1 between the third side HN3 and each of the first bridge circuit 151, the control circuit 120, and the first current detection circuit 111. The second wiring LN2 may be wired along the first direction DR1 between the fourth side HN4 and each of the second bridge circuit 152, the control circuit 120, and the second current detection circuit 112.

According to the embodiment, by wiring the first wiring LN1 and the second wiring LN2 along the outer periphery of the integrated circuit device 100, the first wiring LN1 and the second wiring LN2 can be made linear, that is, as short as possible, without being affected by the wirings in the circuit of the integrated circuit device 100. Since the first wiring LN1 and the second wiring LN2 are not affected by the wirings in the circuit of the integrated circuit device 100, the first wiring LN1 and the second wiring LN2 can be formed using a metal layer having a resistance value as low as possible. Thus, the parasitic resistance values of the first wiring LN1 and the second wiring LN2 can be reduced.

In the embodiment, the first wiring LN1 and the second wiring LN2 may be wired symmetrically with respect to the center line between the third side HN3 and the fourth side HN4.

According to the embodiment, since the first wiring LN1 and the second wiring LN2 are line-symmetric, the resistance values of the first wiring LN1 and the second wiring LN2 can be aligned. Since the amplitude of the drive current IS1 and the amplitude of the drive current IS2 can be made the same, the stepping motor is appropriately controlled.

Although the embodiment is described in detail above, those skilled in the art could easily understand that many modifications are possible without substantially departing from the novel matters and the effects of the disclosure. Therefore, all such modifications are included in the scope of the disclosure. For example, a term described at least once together with a different term having a broader meaning or the same meaning in the specification or the drawings can be replaced with the different term at any place in the specification or the drawings. All combinations of the embodiment and the modifications are also included in the scope of the disclosure. The configurations and operations of the first current detection circuit, the second current detection circuit, the control circuit, the first bridge circuit, the second bridge circuit, the integrated circuit device, the package, the circuit substrate, the motor driver, the motor, or the like are not limited to those described in the embodiment, and various modifications are possible.

What is claimed is:

1. An integrated circuit device comprising:
a first bridge circuit configured to drive a motor;
a first current detection circuit configured to detect a first current flowing through a first sense resistor;
a control circuit configured to control the first bridge circuit based on a detection result of the first current detection circuit;
a first terminal coupled to one end of the first sense resistor and the first bridge circuit;
a second terminal coupled to the one end of the first sense resistor; and
a first wiring, wherein
the first bridge circuit is provided closer to a first side of the integrated circuit device than the control circuit,
the first current detection circuit, when an opposite side of the first side is defined as a second side of the integrated circuit device, is provided closer to the second side than the control circuit, and
the first terminal and the second terminal are provided closer to the first side than the control circuit,
the first wiring couples the second terminal provided closer to the first side than the control circuit to an input node of the first current detection circuit provided closer to the second side than the control circuit.

2. The integrated circuit device according to claim 1, wherein
when a direction from the first side to the second side is defined as a first direction, the first wiring is wired along the first direction.

3. The integrated circuit device according to claim 2, wherein
when a side intersecting the first side and the second side is defined as a third side of the integrated circuit device, the first wiring is wired along the first direction between the third side and each of the first bridge circuit, the control circuit, and the first current detection circuit.

4. The integrated circuit device according to claim 1, further comprising:
a plurality of pads provided along a third side of the integrated circuit device intersecting the first side and the second side, wherein
the first wiring is wired between the plurality of pads and the third side.

5. The integrated circuit device according to claim 4, wherein
when a direction from the first side toward the second side is defined as a first direction, the first wiring is wired along the first direction between the plurality of pads and the third side.

6. The integrated circuit device according to claim 4, wherein
the first wiring is a wiring formed of an uppermost metal layer of the integrated circuit device.

7. The integrated circuit device according to claim 6, wherein
when a direction from the first side toward the second side is defined as a first direction,
a ground wiring formed of the uppermost metal layer is wired along the first direction inside the plurality of pads, and
the first wiring formed of the uppermost metal layer is wired along the first direction between the plurality of pads and the third side.

8. The integrated circuit device according to claim 1, wherein
the first terminal and the second terminal are disposed at a corner portion where a third side of the integrated circuit device intersecting the first side and the second side intersects the first side.

9. The integrated circuit device according to claim 1, wherein
the first current detection circuit includes an amplifier circuit that amplifies an input voltage corresponding to the first current.

10. The integrated circuit device according to claim 9, wherein
the amplifier circuit includes
an operational amplifier,
a first resistor having one end coupled to a first input terminal of the operational amplifier and the other end to which the input voltage is input,
a second resistor having one end coupled to the first input terminal of the operational amplifier and the other end to which a ground voltage or a reference voltage is input,
a third resistor having one end coupled to a second input terminal of the operational amplifier and the other end coupled to a ground node, and
a fourth resistor having one end coupled to the second input terminal of the operational amplifier and the other end coupled to an output terminal of the operational amplifier.

11. The integrated circuit device according to claim 9, wherein
the first current detection circuit includes
a D/A conversion circuit that performs D/A conversion on a target current value of the first current, and
a comparison circuit that compares an output voltage of the amplifier circuit with an output voltage of the D/A conversion circuit, and
the control circuit controls the first bridge circuit based on an output signal of the comparison circuit.

12. The integrated circuit device according to claim 1, further comprising:
a second bridge circuit configured to drive the motor;
a second current detection circuit configured to detect a second current flowing through a second sense resistor;
a third terminal coupled to one end of the second sense resistor and the second bridge circuit;
a fourth terminal coupled to the one end of the second sense resistor; and
a second wiring, wherein
the control circuit controls the second bridge circuit based on a detection result of the second current detection circuit,
the second bridge circuit is provided closer to the first side than the control circuit,
the second current detection circuit is provided closer to the second side than the control circuit,
the third terminal and the fourth terminal are provided closer to the first side than the control circuit, and
the second wiring couples the fourth terminal provided closer to the first side than the control circuit to an input node of the second current detection circuit provided closer to the second side than the control circuit.

13. The integrated circuit device according to claim 12, wherein
when a direction from the first side toward the second side is defined as a first direction, a side intersecting the first side and the second side is defined as a third side of the integrated circuit device, and an opposite side of the third side is defined as a fourth side of the integrated circuit device,
the first wiring is wired along the first direction between the third side and each of the first bridge circuit, the control circuit, and the first current detection circuit, and
the second wiring is wired along the first direction between the fourth side and each of the second bridge circuit, the control circuit, and the second current detection circuit.

14. The integrated circuit device according to claim 12, wherein
when a side intersecting the first side and the second side is defined as a third side of the integrated circuit device and an opposite side of the third side is defined as a fourth side of the integrated circuit device, the first wiring and the second wiring are wired symmetrically with respect to a center line between the third side and the fourth side.

15. A motor driver comprising:
the integrated circuit device according to claim 1; and
the first sense resistor.
